(19) United States
(12) Patent Application Publication
(10) Pub. No.: US 2025/0200553 A1
(43) Pub. Date: Jun. 19, 2025

(54) METHOD FOR DID AUTHENTICATION USING SMART CARD AND SMART CARD DEVICE

(71) Applicant: BLOCKCHAIN LABS INC., Seoul (KR)

(72) Inventors: Yong Tae KIM, Seoul (KR); Byung Wan LIM, Seoul (KR)

(73) Assignee: BLOCKCHAIN LABS INC., Seoul (KR)

(21) Appl. No.: 18/709,142

(22) PCT Filed: Nov. 10, 2022
(86) PCT No.: PCT/KR2022/017643

§ 371 Date: Nov. 8, 2024

(30) Foreign Application Priority Data
Nov. 11, 2021 (KR) 10-2021-0154502

(51) Int. Cl. G06Q 20/34; G06Q 20/38

(52) U.S. Cl. CPC G06Q 20/34; G06Q 20/3825; G06Q 20/389

(57) ABSTRACT

Disclosed is a smart card including a communication circuit configured to communicate with a reader associated with an authentication service, a memory for storing a program associated with the authentication service, a decentralized identifier, and a VC list, and at least one processor operatively connected to the memory and configured to execute instructions, in which the at least one processor is configured to transmit a VC included in the VC list and associated with the authentication request to the reader when receiving an authentication request from the reader, and generate an electronic signature, when receiving a hash value generated based on at least a piece of information included in the VC, based on the hash value and the decentralized identifier set and transmit the generated electronic signature to the reader. In addition to this, various embodiments grasped through the specification are possible.

### TECHNICAL FIELD

Embodiments disclosed herein relate to an authentication method using a decentralized identifier (DID).

### BACKGROUND ART

Traditionally, ID management has been carried out by trusted institutions. However, with the widespread use of distributed ledger technology such as blockchain, it has become possible for individuals to have control over their own information through decentralized identifiers while still enabling trustworthy identity authentication without relying on trusted institutions. In this regard, international standards are being established through the World Wide Web Consortium (W3C) against the backdrop of blockchain technology.

### DISCLOSURE OF THE INVENTION

### Technical Problem

In an authentication service using a decentralized identifier based on blockchain technology, the user terminal or the service provider's server should perform operations such as generating a VC (Verifiable Credentials, hereinafter referred to as VC) and a VP (Verifiable Presentation, hereinafter referred to as VP) in response to an authentication request, and generating an electronic signature based on the decentralized identifier.

To provide an authentication service using a decentralized identifier based on blockchain technology, for example, a service provider distributes an application that includes a blockchain wallet to users. Users install the application and use the authentication service through that application.

Therefore, it is difficult to provide a decentralized identifier-based authentication service through devices with limited hardware resources (e.g., smart cards) because it is challenging to operate related functions through such devices. The various embodiments disclosed in this document aim to provide a smart card that offers decentralized identifier-based authentication functionality and an authentication method utilizing the smart card.

### Technical Solution

According to an embodiment disclosed in this document, a smart card includes a communication circuit configured to communicate with a reader associated with an authentication service, a memory for storing a program associated with the authentication service, a decentralized identifier, and a VC list, and at least one processor operatively connected to the memory and configured to execute instructions, and the at least one processor is configured to transmit a VC included in the VC list and associated with the authentication request to the reader when receiving an authentication request from the reader, and generate an electronic signature, when receiving a hash value generated based on at least a piece of information included in the VC, based on the hash value and the decentralized identifier set and transmit the generated electronic signature to the reader.

According to another embodiment disclosed in this document, a method for authentication includes receiving, by a smart card, an authentication request from a reader, transmitting, by the smart card to the reader, a VC that is stored in the smart card and associated with the authentication request, generating, by the reader, VP information, which is information to be included in a VP, as at least a piece of the information included in the VC, and generating a hash value based on the VP information, transmitting, by the reader, the hash value and an electronic signature request for the hash value to the smart card, generating, by the smart card, an electronic signature based on a decentralized identifier set stored in the smart card and the received hash value, and transmitting the generated electronic signature to the reader, generating, by the reader, a VP including the electronic signature and the VP information, and transmitting, by the reader, the VP to a verifier associated with the authentication request.

### Advantageous Effects

According to the embodiments disclosed in this document, a decentralized identifier-based authentication service can be provided using a smart card with limited hardware resources. Users can perform authentication conveniently using the smart card. Besides, various effects may be provided that are directly or indirectly identified through the present disclosure.

### BRIEF DESCRIPTION OF THE DRAWINGS

FIG. 1 is a diagram illustrating an overview of an identity authentication service using a smart card in accordance with an embodiment.

FIG. 2 is a block diagram of a smart card according to an embodiment.

FIG. 3 is a signal sequence diagram illustrating an authentication method in accordance with an embodiment.

FIG. 4 is a signal sequence diagram showing a process in which an issuing system issues a smart card in accordance with an embodiment.

FIG. 5 is a signal sequence diagram of an identity authentication method with enhanced security using encryption keys in accordance with an embodiment.

FIG. 6 is a signal sequence diagram showing a method in which an issuing system issues a VC to a smart card or manages a VC stored in the smart card in accordance with an embodiment.

FIG. 7 is a flowchart showing a process in which a smart card and an issuing system (or a reader) generate a blockchain transaction in accordance with an embodiment.

FIG. 8 is a flowchart of an authentication method by a smart card in accordance with an embodiment.

With respect to the description of the drawings, the same or similar reference signs may be used for the same or similar elements.

### MODE FOR CARRYING OUT THE INVENTION

Hereinafter, various embodiments of the present disclosure will be described with reference to the accompanying drawings. However, this is not intended to limit the present disclosure to specific embodiments, and should be understood to include various modifications, equivalents, and/or alternatives of the embodiment of the present disclosure.

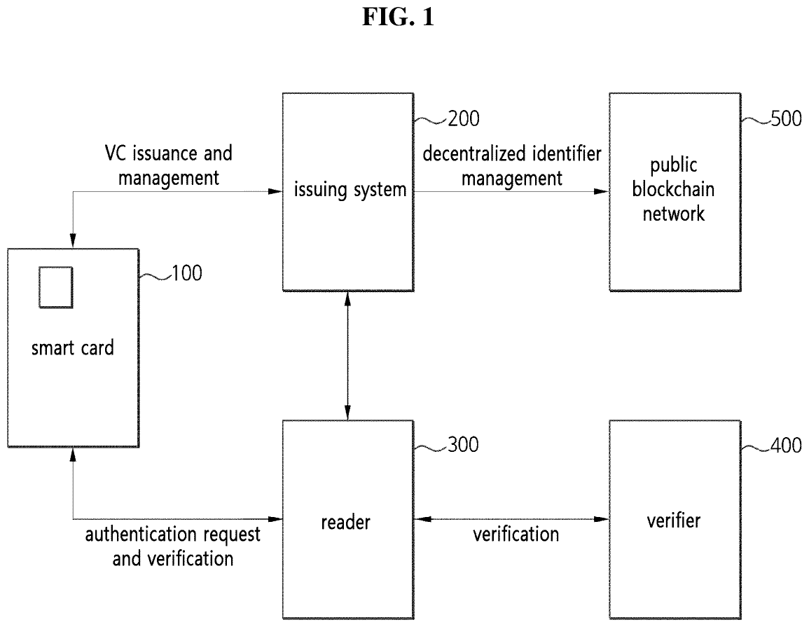

FIG. 1 is a diagram illustrating an overview of an identity authentication service using a smart card in accordance with an embodiment.

Referring to FIG. 1, a decentralized identifier-based identity authentication service using a smart card is provided by a smart card 100, an issuing system 200, a reader 300, and a verifier 400.

The smart card 100 is a smart card device owned by a user who is the subject of identity authentication. The smart card 100 can be understood as an electronic card with its own computational capabilities, such as s a chip card or an integrated circuit (IC) card.

The smart card 100 can generate a decentralized identifier set of the user. The decentralized identifier set may include a public key and a private key that can be used as an account in a public blockchain network 500. In an embodiment, the public key may be used as a decentralized identifier (DID) in the authentication service.

In various embodiments, the decentralized identifier set may further include a separate identifier corresponding to the public key. The separate identifier may be, for example, another key value used for the user in the identity authentication service separately from the public key. In this case, the separate identifier may be used as a decentralized identifier in the authentication service. The decentralized identifier mentioned in the following description may refer to the public key or the separate identifier.

The public blockchain network 500 may include a decentralized identifier document (DID document). The DID document may be managed by the issuing system 200. The DID document may include the decentralized identifier of the smart card 100 and information associated with that decentralized identifier. The information associated with the decentralized identifier may include status information of the decentralized identifier (e.g., valid status, revoked status). In addition, the DID document may include a public key matching the decentralized identifier. Those who want to verify a VC or VP can acquire the public key that can decrypt their electronic signatures from the public blockchain network 500 based on the decentralized identifier of the creator of the VC or the creator of the VP (DID resolution).

The smart card 100 can store one or more VCs issued for the user's decentralized identifier. In addition, the smart card 100 can generate an electronic signature based on the private key included in the decentralized identifier set. The VCs can be issued by the issuing system 200 or other organizations. The decentralized identifier of the VC issuer can be registered in the DID document on the public blockchain network 500.

The issuing system 200 can be understood as a server device operated by an entity that issues the smart card 100 and/or an entity that issues VCs for the user. The entity that issues the smart card 100 and the entity that issues VCs may be different, and there may be multiple entities that issue VCs. The issuing system 200 may include one or more server devices.

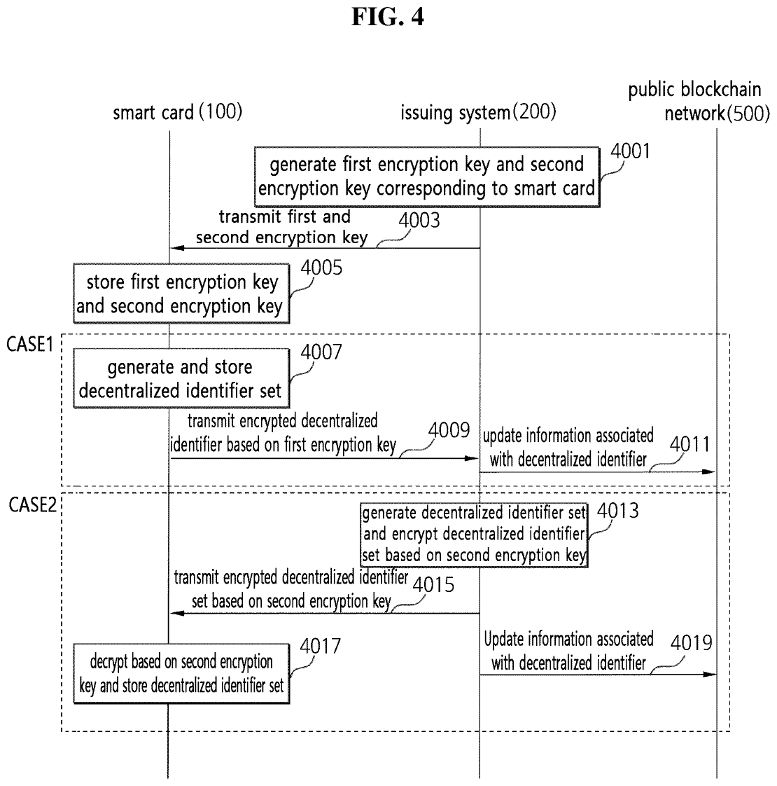

The issuing system 200 can perform a card issuance procedure by having a program related to the authentication service installed on the smart card 100. In an embodiment, the issuing system 200 can manage the decentralized identifier of the smart card 100, information about the smart card 100 matched to the decentralized identifier (e.g., card serial number), and information associated with the user of the smart card 100 (e.g., user ID, name, contact information). In addition, the issuing system 200 can manage information associated with the user's decentralized identifier. The information associated with the decentralized identifier may include status information of the decentralized identifier (e.g., valid status, revoked status). The issuing system 200 can update the information associated with the decentralized identifier on the public blockchain network 500 (e.g., steps 4011 and 4019 in FIG. 4). In various embodiments, the decentralized identifier can be generated by the issuing system 200. In this case, the issuing system 200 encrypts the generated decentralized identifier and transmits the encrypted decentralized identifier to the smart card 100. Further details will be described below with reference to FIG. 4.

The issuing system 200 can issue VC that include various certifiable information such as the user's identity authentication information and other private information, as well as the electronic signature of the issuing system 200. The issuer's electronic signature included in the VC may vary depending on the issuing entity of the VC.

The reader 300 can be understood as a device that communicates with the smart card 100 and can read the information included in the smart card 100. The reader 300 includes, for example, devices that can communicate with the smart card 100, such as a point of sale (POS) terminal, a kiosk, and a portable card reader equipped with communication capabilities.

In various embodiments, the reader 300 may perform contact communication through physical contact between the contact point (e.g., chip) of the smart card 100 or perform contactless wireless communication through NFC communication. Alternatively, the reader 300 and the smart card 100 may perform communication in a combo method for both contact and contactless methods.

The reader 300 may communicate with the issuing system 200. The reader 300 may be managed by the card issuing entity, and a program related to the authentication service that enables the smart card 100, the issuing system 200, and the reader 300 to operate in conjunction with each other may be installed on the reader 300.

The reader 300 may transmit an authentication request for specific information to the smart card 100 and acquire a VC associated with the authentication request from the smart card 100. In various examples, the specific information may include identity information such as the user's name and age, affiliation information, qualification information, etc.

The verifier 400 can be understood as a server device operated by an entity that intends to perform authentication for a user in the authentication service. For example, the verifier 400 may verify private information about the user, such as the user's identity information like whether the user is an adult, affiliation information such as the company or school to which the user belongs, etc., through the reader 300.

For example, when an operation such as payment or access permission is performed through the reader 300, the reader 300 may perform authentication for information matching the specific operation in cooperation with the smart card 100, the issuing system 200, and the verifier 400.

Hereinafter, the and smart card 100 the authentication method using the smart card 100 will be described according to the standard specifications of the World Wide Web Consortium (W3C), a web standardization organization.

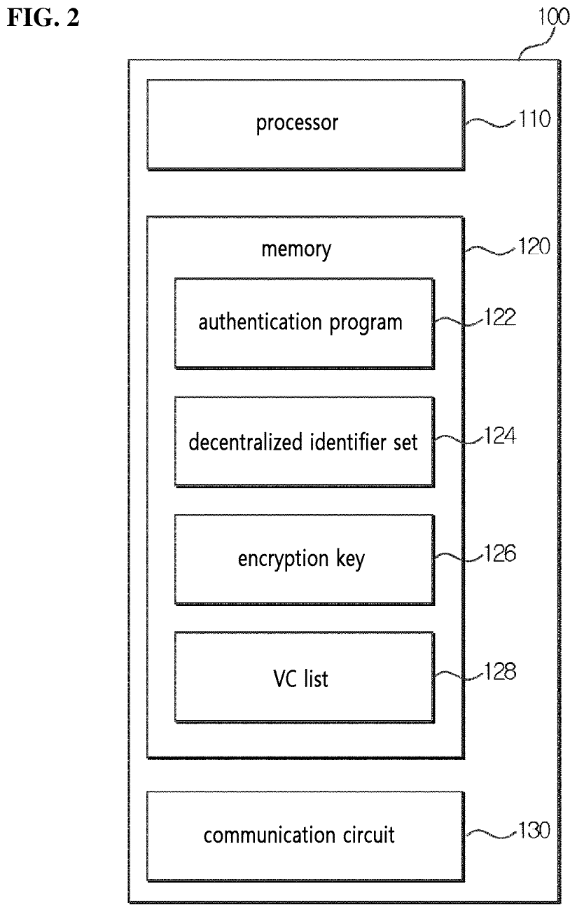

FIG. 2 is a block diagram of a smart card 100 according to an embodiment. The smart card 100 may include a processor 110, a memory 120, and a communication circuit 130. The processor 110 may control the overall operation of the smart card 100. For example, the processor 110 may be a microprocessor and an arithmetic processing unit, and may include one or more processors for controlling the smart card 100. The processor 110 may be operatively connected to the memory 120 and configured to execute instructions (e.g., authentication program 120) stored in the memory 120.

The communication circuit 130 may be configured to communicate with the issuing system 200 and the reader 300 associated with the authentication service. The smart card 100 may transmit and receive data with the issuing system 200 and the reader 300 through the communication circuit 130. The communication circuit 130 may support contact communication and/or contactless communication (e.g., NFC).

The memory 120 may include an authentication program 122, a decentralized identifier set 124, encryption key 126, and a VC list 128. The authentication program 122 can be understood as a program for providing the authentication service. For example, the smart card 100 may be a JavaCard, and a Java applet for providing the identity authentication service may be installed on the smart card 100.

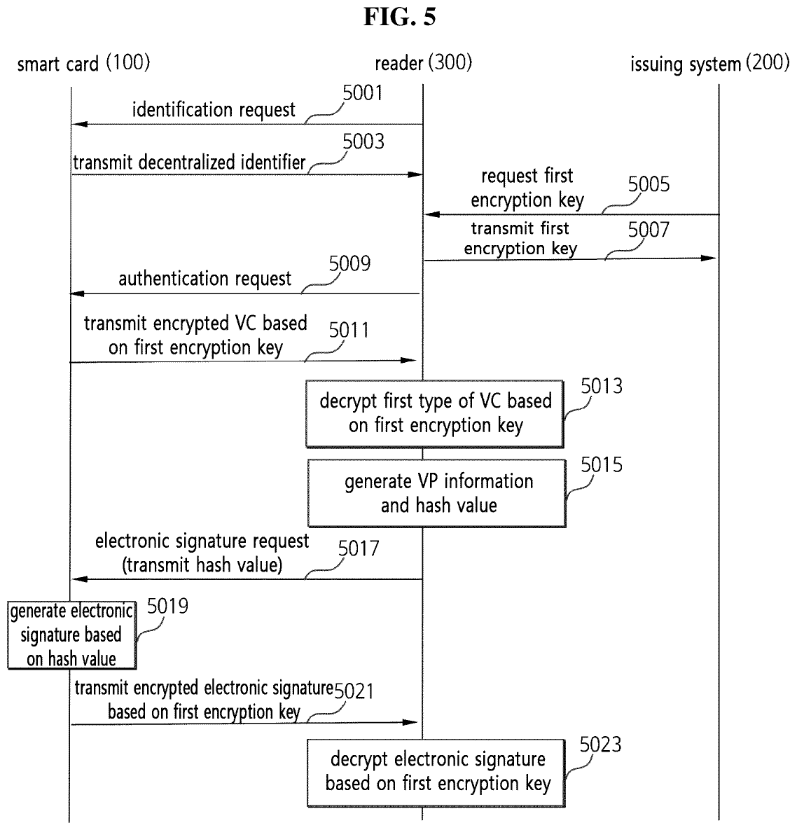

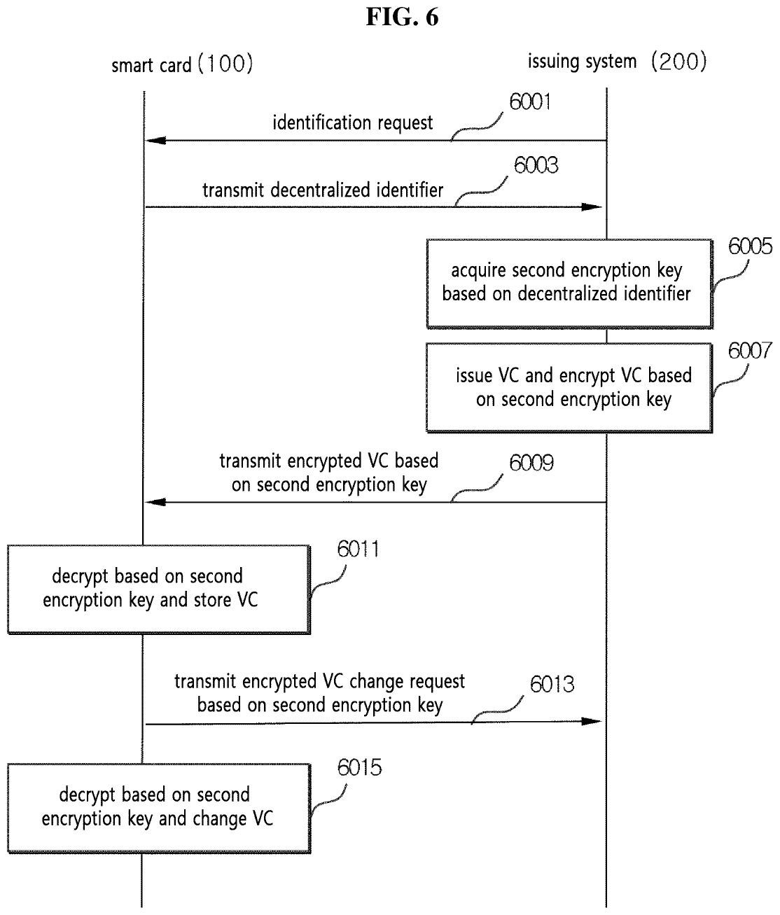

The decentralized identifier set 124 may be implemented based on the ECDSA encryption algorithm using the secp256k1 curve or the RSA encryption algorithm. The encryption key 126 is a encryption key used for security when communicating with the issuing system 200 and the reader 300 for the authentication service, and details will be described later through FIGS. 5 and 6.

The VC list 128 may include one or more VCs issued to the user of the smart card 100 which are distributed through an authentication service.

In an embodiment, the type of VC distributed through the authentication service may be classified. For example, the VC list 128 may include multiple VCs stored by VC type. The issuing system 200 may store, retrieve, or delete VCs by VC type. The reader 300 may retrieve VCs by VC type. The smart card 100 may be reset to be reusable.

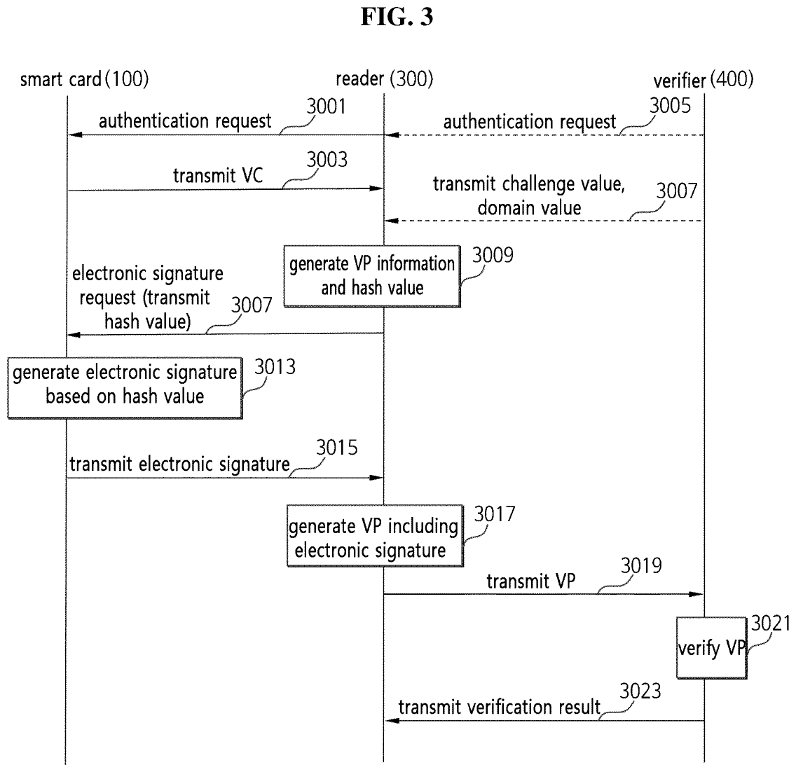

FIG. 3 is a signal sequence diagram illustrating an authentication method in accordance with an embodiment.

In an embodiment, the smart card 100 may receive an authentication request from the reader 300 (3001). The smart card 100 may transmit a VC stored in the smart card 100 and associated with the authentication request to the reader 300 (3003).

In various embodiments, the authentication request may include VC type information indicating the type of VC. The smart card 100 may transmit one or more VCs matching the VC type information included in the authentication request to the reader 300. One authentication request may include a plurality of VC type information, and in this case, a plurality of VCs of different types may be transmitted to the reader 300.

For example, the authentication request may be understood as a read request for a specific VC. The reader 300 may transmit read requests multiple times for each VC of different types.

In an embodiment, the reader 300 may generate VP information, which is information to be included in a VP, as at least a piece of the information included in the VC (3009). VP information can be understood as information corresponding to an item for which authentication has been requested by the verifier 400. The reader 300 may determine the information to generate a VP from at least one VC received from the smart card 100. The VP information may include two or more different types of VCs. For example, VP information combining an identity authentication VC and a student ID VC may be generated.

The reader 300 may generate a hash value based on the VP information (3011). The hash value is a unique value matched to the VP information, for example, the hash value may be a hash value (e.g., 256-bit SHA 256 hash value) for the VP information.

The reader 300 may transmit the hash value and an electronic signature request for the hash value to the smart card 100 (3011). The smart card 100 may generate an electronic signature based on the decentralized identifier stored in the smart card 100 and the received hash value (3013), and transmit the generated electronic signature to the reader 300 (3015). The reader 300 may finally generate a VP including the electronic signature transmitted from the smart card 100 and the VP information (3017).

Since the hardware resources of the smart card 100 such as the size of the memory or the performance of the processor are limited, it may be difficult to perform the entire procedure of generating a VP on the smart card 100. Therefore, in order to generate the VP, the process of combining the information to be included in the VP may be performed by the reader 300, and the smart card 100 may perform only the electronic signature on the hash value of the VP information based on the pre-stored private key, so that the procedure of generating the VP may be performed in cooperation between the reader 300 and the smart card 100.

In an embodiment, the reader 300 may transmit the generated VP to the verifier 400 associated with the authentication request (3019). The verifier 400 may verify the received VP (3021) and transmit the verification result to the reader 300 (3023). Verification of the VP includes verification of the issuer of the VC included in the VP, the owner of the VC, and the information included in the VP.

In various embodiments, when the reader 300 receives the verification result from the verifier 400 (3023), the reader 300 may process the authentication request based on the verification result. For example, if a verification result of permission is received for an authentication request for access permission, the reader 300 may control the access door operated by the reader 300 to open to allow the user to enter. Alternatively, if a verification result of non-permission is received, the reader 300 may control the access door to close. In addition, the authentication method may be utilized in various embodiments such as determining sales permission according to age and discounting payment amounts according to affiliation.

In various embodiments, the reader 300 may receive a challenge value and/or a domain value associated with a specific authentication request from the verifier 400 (3007). The challenge value may be understood as a newly generated random value when a specific authentication request (e.g., step 3005) occurs. The domain value is the domain VP that will be used, which is the identification information of the target to which the VP will be submitted. For example, if the target to which the VP is to be submitted for a specific authentication request is the verifier 400, the domain value may be the identification information of the verifier 400 or the identification information of a service or company associated with the verifier 400.

In step 3007 according to an embodiment, if the reader 300 receives a challenge value, the reader 300 may generate the hash value based on the generated VP information and the challenge value in step 3009 (3009). The smart card 100 will perform an electronic signature on the hash value reflecting both the VP information and the challenge value (3013). The challenge value allows the verifier 400 to verify whether the VP has been newly generated for a specific authentication request.

In another embodiment of step 3007, if the reader 300 receives a domain value, the reader 300 may generate the hash value based on the generated VP information and the domain value in step 3009. The smart card 100 will perform an electronic signature on the hash value reflecting both the VP information and the domain value (3013). The domain value allows the verifier 400 to verify whether the VP is a VP generated for the target (e.g., the verifier 400 itself) to which the VP will be submitted.

In another embodiment of step 3007, if the reader 300 receives a challenge value and a domain value, the reader 300 may generate the hash value based on the generated VP information, the challenge value, and the domain value in step 3009. The smart card 100 will perform an electronic signature on the hash value reflecting the VP information, the challenge value, and the domain value (3013). The challenge value and domain value allow the verifier 400 to verify both whether the VP has been newly generated for a specific authentication request and whether the VP is a VP generated for the target (verifier 400) to which the VP will be submitted.

In various embodiments, the authentication request in step 3001 may be generated by the reader 300, or generated by the verifier 400 and delivered to the smart card 100 through the reader 300 (3005).

FIG. 4 is a signal sequence diagram showing a process in which the issuing system 200 issues the smart card 100 in accordance with an embodiment. Referring to FIG. 4, Case 1 is an embodiment in which the decentralized identifier set is generated by the smart card 100, and Case 2 is an embodiment in which the decentralized identifier set is generated by the issuing system 200.

The issuing system 200 may generate encryption keys for encrypting communication performed between the smart card 100 and the issuing system 200, and between the smart card 100 and the reader 300. The issuing system 200 may generate a first encryption key associated with read permission for the smart card 100 and a second encryption key associated with write permission (4001). In an embodiment, the first encryption key and the second encryption key may be generated as symmetric keys based on a symmetric-key algorithm.

The issuing system 200 may manage the unique serial number of the smart card 100 and the first encryption key and the second encryption key for the serial number. The issuing system 200 may manage the public key among the decentralized identifiers issued for the smart card 100. The issuing system 200 may provide the information to the reader 300 as needed.

The issuing system 200 may transmit the generated first encryption key and second encryption key to the smart card 100 (4003). The smart card 100 may store the first encryption key and the second encryption key in the memory 120 (4005). The stored first encryption key and second encryption key correspond to the encryption key 126 of the memory 120 in FIG. 2.

Referring to Case 1, the smart card 100 may generate a decentralized identifier set (4007). The smart card 100 may generate the decentralized identifier set including a pair of keys (public key, private key) and a decentralized identifier that can be used as an account of the public blockchain network 500. As described above, the decentralized identifier may be the public key among the pair of keys or may be a separate identifier.

The generated decentralized identifier set 124 may be stored in the memory 120 (4007). The smart card 100 may encrypt the decentralized identifier (e.g., public key) in the decentralized identifier set 124 based on the first encryption key associated with read permission, and transmit the encrypted decentralized identifier to the issuing system 200 (4009). The issuing system 200 may store the received decentralized identifier by mapping it to the serial number of the smart card 100. The issuing system 200 may update information associated with the newly issued decentralized identifier on the public blockchain network 500 (4011).

Referring to Case 2, the issuing system 200 may generate a decentralized identifier set for the smart card 100 (4013).

The issuing system 200 may encrypt the generated decentralized identifier set based on the second encryption key associated with write permission (4013), and transmit the encrypted decentralized identifier set to the smart card 100 (4015). The smart card 100 may decrypt the encrypted decentralized identifier set based on the second encryption key stored in the smart card 100, and store the decentralized identifier set 124 including the public key and the private key in the memory 120 (4017). The issuing system 200 may update information associated with the newly issued decentralized identifier on the public blockchain network 500 (4019).

In various embodiments, if the smart card 100 supports decentralized identifiers of the Secp256k specification, the smart card 100 may directly generate electronic signatures of the Secp256k specification. Since blockchain networks mainly support decentralized identifiers of the Secp256k specification, in this case, the verifier 400 can directly verify the VP through the blockchain network based on the electronic signature generated by the smart card 100.

In various embodiments, if the smart card 100 does not support the Secp256k1 elliptic curve encryption algorithm for generating an account of the blockchain network, the decentralized identifier set may be configured based on the RSA encryption algorithm.

The smart card 100 may generate a first public key and a first private key as a key pair based on the RSA encryption algorithm (e.g., step 4007). The first public key and the first private key based on the RSA encryption algorithm may be included in the decentralized identifier set. The smart card 100 may transmit the first public key to the issuing system 200 (e.g., step 4009). The issuing system 200 may generate a second public key and a second private key as a key pair based on the Secp256k1 elliptic curve encryption algorithm for the first public key generated by the smart card 100. In this case, any one of the first public key, the second public key, or a separate key may be used as a decentralized identifier corresponding to the smart card 100.

The first public key, the second public key, and the decentralized identifier may be registered on the public blockchain network 500 by the issuing system 200 as information associated with the decentralized identifier of the smart card 100 (step 4011 of FIG. 4). The issuing system 200 may manage the first public key, the second private key, and the second public key together.

In step 3013 of FIG. 3, the smart card 100 may generate an electronic signature with the first private key based on the RSA algorithm, and in step 3017, the VP generated by the reader 300 may include an electronic signature based on the RSA algorithm. In step 3021, the verifier 300 may perform verification of the RSA algorithm-based electronic signature that generated the VP based on the decentralized identifier of the smart card 100 registered on the public blockchain network 500. The issuer signature of the VC included in the VP may be a signature generated based on the Secp256k1 elliptic curve encryption algorithm, so the verifier 300 may also perform verification of the VC issuer based on the DID document of the VC issuer registered on the public blockchain network 500.

FIG. 5 is a signal sequence diagram of an identity authentication method with enhanced security using encryption keys in accordance with an embodiment. The first encryption key generated in FIG. 4 may be used when the reader 300 retrieves data stored in the smart card 100 or sends an electronic signature request to the smart card 100. This can enhance the security of communication between the smart card 100 and the reader 300.

Steps 5009, 5011, 5013, 5015, 5017, and 5019 of FIG. 5 correspond to steps 3001, 3003, 3009, 3011, 3013, and 3015 of FIG. 3. The same operations as in FIG. 3 may be performed except for the operations described in FIG. 5.

The reader 300 may transmit an identification request to the smart card 100 (5001). In response to the identification request, the smart card 100 may transmit the public key among the decentralized identifier set 124 to the reader 300. For example, the first encryption key request may include the serial number and public key of the reader 300. For example, steps 5001 and 5003 may be performed before the authentication request in step 3001 of FIG. 3.

The reader 300 may request the issuing system 200 for the first encryption key for the smart card 100 corresponding to the public key (5005). The issuing system 200 may check whether the request is from the reader 300 managed by the issuing system 200, and then transmit the first encryption key to the reader 300 (5007). For example, the issuing system 200 may check whether the serial number of the reader 300 is managed by the issuing system 200 and transmit the first encryption key for the public key to the reader 300.

When the first encryption key is used, the smart card 100 may encrypt the VC based on the first encryption key stored in the smart card 100 for the authentication request from the reader 300 (5009), and transmit the encrypted VC to the reader 300 (5011). The reader 300 may decrypt the encrypted VC based on the first encryption key received from the issuing system 200 in step 5007 (5013).

If the decryption is successful, the reader 300 may generate VP information and a hash value (5013), and transmit an electronic signature request including the hash value to the smart card 100 (5017).

The smart card 100 may generate an electronic signature based on the hash value and the decentralized identifier (5019), and encrypt the generated electronic signature with the first encryption key. The smart card 100 may transmit the electronic signature encrypted based on the first encryption key to the reader 300 (5021). The reader 300 may decrypt the encrypted electronic signature based on the first encryption key received from the issuing system 200 (5023). Thereafter, steps 3017 to 3023 described in FIG. 3 may be performed.

FIG. 6 is a signal sequence diagram showing a method in which an issuing system 200 issues a VC to a smart card 100 or manages a VC stored in the smart card 100 in accordance with an embodiment. As described above, the entity of the issuing system 200 that issues and manages VCs may be different from the entity of the issuing system 200 that issues cards in FIG. 4.

When a request for VC issuance is received from the smart card 100, the issuing system 200 may transmit an identification request to the smart card 100 (6001). In response to the identification request, the smart card 100 may transmit the decentralized identifier among the decentralized identifier set 124 to the issuing system 200 (6003).

The issuing system 6005 may acquire the second encryption key previously issued for the smart card 100 based on the received decentralized identifier (6005).

The issuing system 200 may issue a VC corresponding to the VC issuance request of the smart card 100 and encrypt the issued VC based on the second encryption key (6007). The issuing system 200 may transmit the encrypted VC to the smart card 100 (6009).

The smart card 100 may decrypt the encrypted VC based on the second encryption key 126 stored in the smart card 100 and store it in the VC list 128 of the memory 120 (6011).

In various embodiments, even when changes such as deletion or modification are required for VCs previously issued by the issuing system 200, an encrypted VC change request based on the second encryption key may be transmitted (6013). The smart card 100 may decrypt the encrypted VC change request based on the second encryption key 126 stored in the smart card 100, and modify or delete the VC list 128 according to the change request.

The smart card 100 may confirm that the addition or change request for the VC list 128 is made by the subject having the second encryption key, and execute the change request.

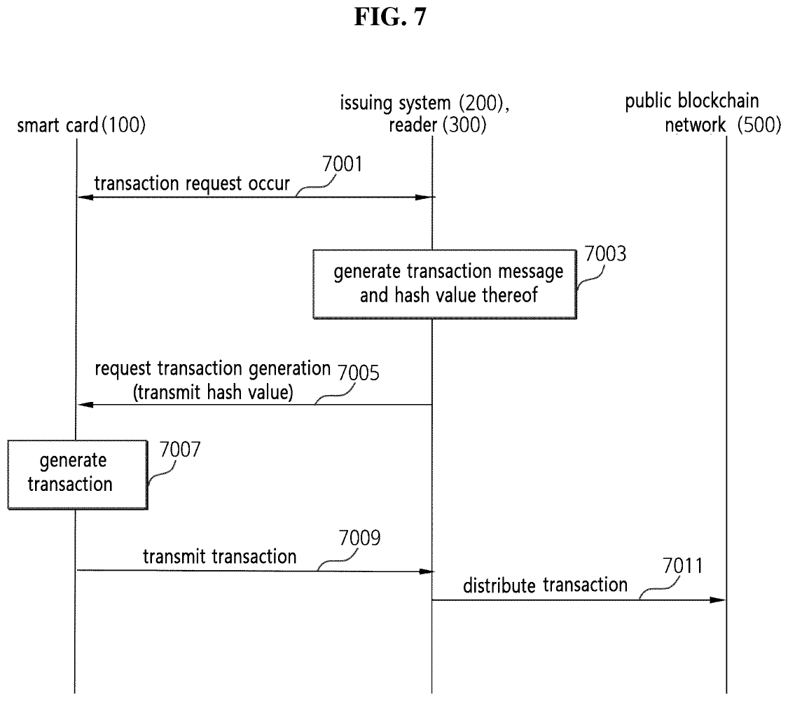

FIG. 7 is a flowchart showing a process in which a smart card 100 and an issuing system 200 (or a reader 300) generate a blockchain transaction in accordance with an embodiment. The smart card 100 can function as a hardware wallet of the blockchain network 500 as it stores blockchain account information (private key and public key of the decentralized identifier set 124). In various embodiments, the issuing system 100 and the reader 300 may generate a blockchain transaction based on the blockchain account of the smart card 100 in cooperation with the smart card 100.

When a transaction request occurs (7001), the issuing system 200 (or the reader 300) may generate a blockchain transaction message and generate a hash value for the transaction message (7003).

The issuing system 200 (or the reader 300) may transmit a transaction generation request to the smart card 100 (7005). The transaction generation request includes the hash value for the transaction message. The smart card 100 may generate a blockchain transaction by signing the hash value (7007) and transmit the blockchain transaction to the issuing system 200 (or the reader 300) (7009). The issuing system 200 (or the reader 300) may distribute the received blockchain transaction to the blockchain network 500 (7011).

For example, the process of FIG. 7 may be included in a payment procedure between the reader 300 and the smart card 100. In step 7001, when a payment request occurs between the reader 300 and the smart card 100, a payment transaction request using cryptocurrency or tokens of the blockchain network 500 may occur simultaneously. In step 7003, the reader 300 may generate a transaction message including information related to payment such as the amount to be paid, the address to transfer, and the transaction number, and generate a hash value for it. When the payment transaction is generated and distributed to the blockchain network 500, the transfer of cryptocurrency or tokens from the blockchain account of the smart card 100 may be executed.

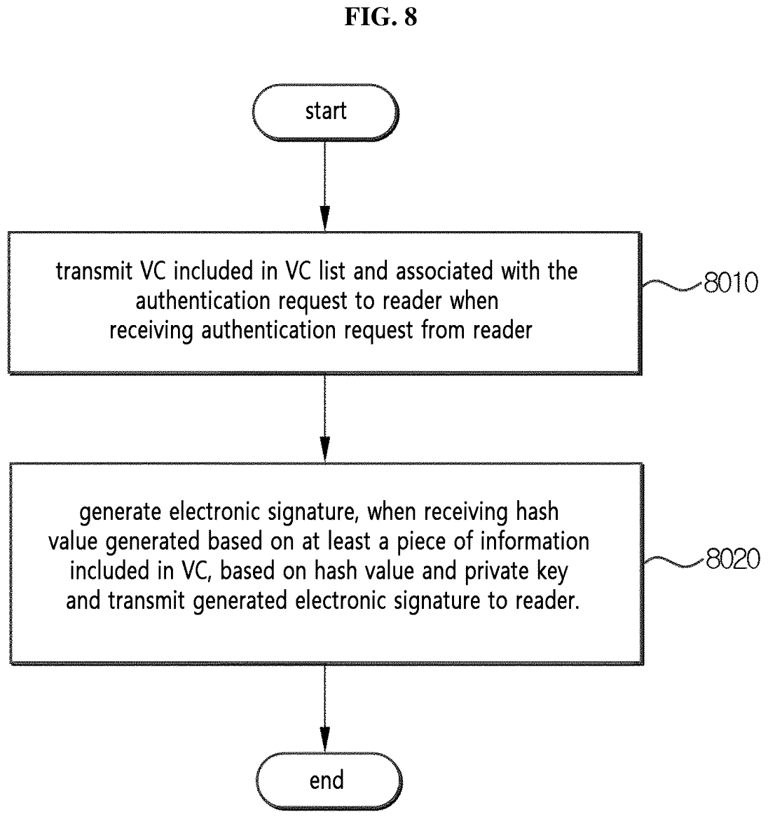

FIG. 8 is a flowchart of an authentication method by a smart card 100 in accordance with an embodiment.

When the smart card 100 receives an authentication request from the reader 300, the smart card 100 may transmit a VC included in the VC list 128 and associated with the authentication request to the reader 300 (8010).

When the smart card 100 receives a hash value generated based on at least a piece of information included in the VC from the reader 300, the smart card 100 may generate an electronic signature based on the hash value and the private key stored in the smart card 100 and transmit the generated electronic signature to the reader 300 (8020).

The smart card 100 transmits the electronic signature generated in step 7020 to the reader 300 to enable the reader 300 to generate a VP based on at least a piece of information included in the VC and the electronic signature.

In an embodiment, the reader 300 operates in conjunction with the issuing system 200, which is the issuing entity of the smart card 100. The smart card 100 may receive a first encryption key associated with read permission for the memory 120 and a second encryption key associated with write permission for the memory 120 from the issuing system 200.

In step 8010 according to various embodiments, the smart card 100 may encrypt the VC based on the first encryption key and transmit the encrypted VC to the reader 300 to verify whether the reader 200 is a device with read permission for the VC.

In various embodiments, when the smart card 100 receives a change request for the VC list from the issuing system 200, it may decrypt the change request based on the second encryption key 126 stored in the memory 120, and perform a change process based on the decrypted change request. Through this, the smart card 100 can verify whether the change request is from an authorized issuing system 200 with write permission to the memory 120.

Electronic devices according to various embodiments disclosed in this document may be devices of various types. The electronic devices may include, for example, a portable communication device (e.g. smartphone), a computer device, a portable multimedia device, a portable medical device, a camera, a wearable device, or a home appliance. The electronic device according to an embodiment of the present document is not limited to the aforementioned devices.

Various embodiments of this document and terms used therein are not intended to limit the technical features described in this document to specific embodiments, and should be understood to include various modifications, equivalents, or alternatives of the embodiments. In relation to the description of the drawings, similar reference numerals may be used for similar or related components. The singular form of a noun corresponding to an item may include one item or a plurality of items, unless the relevant context clearly dictates otherwise. In this document, each of phrases such as “A or B”, “at least one of A and B”, “at least one of A or B”, “A, B or C”, “at least one of A, B and C”, and “at least one of A, B, or C” may include all possible combinations of items listed together in the corresponding phrase among those phrases. Terms such as “first”, “second”, “firstly”, or “secondly” may simply be used to distinguish a corresponding component from other corresponding components, and do not limit the corresponding components in other respects (e.g., importance or order). In this document, if a certain (e.g., first) element is referred to as being “connected” or “coupled” with or without the terms “functionally” or “communicatively” to another (e.g., second) component, it means that the certain component can be connected to the other component directly (e.g., in a wired manner), wirelessly, or through a third component.

The term “module” used in this document may include a unit implemented in hardware, software, or firmware, and may be used interchangeably with terms such as logic, logic block, component, or circuit. A module may be the smallest unit of an integrated component or a part thereof, performing one or more functions. For example, according to an embodiment, the module may be implemented in the form of an ASIC (application-specific integrated circuit).

Various embodiments as set forth herein may be implemented as software (e.g., the program 122) including one or more instructions that are stored in a storage medium (e.g., the memory 120) that is readable by a machine (e.g., the smart card 100). For example, a processor (e.g., the processor 110) of the machine (e.g., the smart card 100) may invoke at least one of the one or more instructions stored in the storage medium, and execute it. This allows the machine to be operated to perform at least one function according to the at least one instruction invoked. The one or more instructions may include a code generated by a compiler or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment, a method according to various embodiments disclosed in this document may be provided by being included in a computer program product. The computer program product may be traded between a seller and a buyer as a commodity. The computer program product may be distributed in the form of a machine-readable storage medium (e.g., compact disc read only memory (CD-ROM)), or may be distributed (e.g., downloaded or uploaded) online, through an application store (e.g., Play Store™) or directly between two user devices (e.g., smartphones). In the case of online distribution, at least part of the computer program product may be temporarily stored or tentatively generated in the machine-readable storage medium such as a memory of a manufacturer's server, application store server, or relay server.

According to various embodiments, each component (e.g., module or program) of the components described above may include one or a plurality of entities. According to various embodiments, one or more components among the components described above or operations may be omitted, or one or more other components or operations may be added. Alternatively or additionally, a plurality of components (e.g., modules or programs) may be integrated into one component. In this case, the integrated component may perform one or more functions of each component of the plurality of components identically or similarly to those functions performed by a corresponding component among the plurality of components prior to the integration. According to various embodiments, operations performed by modules, programs, or other components may be executed sequentially, in parallel, iteratively, or heuristically, or one or more of the operations may be executed in a different order or omitted, or, one or more other operations may be added.

1. A method for authentication, the method comprising:
receiving, by a smart card, an authentication request from a reader;
transmitting, by the smart card, a VC (Verifiable Credentials) stored in the smart card and associated with the authentication request to the reader;
generating, by the reader, VP (Verifiable Presentation) information, which is information to be included in a VP as at least a piece of the information included in the VC, and generating a hash value based on the VP information;
transmitting, by the reader, the hash value and an electronic signature request for the hash value to the smart card;
generating, by the smart card, an electronic signature based on a decentralized identifier set stored in the smart card and the received hash value, and transmitting the generated electronic signature to the reader;
generating, by the reader, a VP including the electronic signature and the VP information; and
transmitting, by the reader, the VP to a verifier associated with the authentication request.

2. The method of claim 1, further comprising:
receiving, by the reader, a random value associated with the authentication request from the verifier; and
generating, by the reader, the hash value based on the VP information and the random value.

3. The method of claim 1, further comprising:
receiving, by the reader, a verification result from the verifier; and
processing, by the reader, the authentication request based on the verification result.

4. The method of claim 1, further comprising:
encrypting, by the smart card, the VC based on a first encryption key stored in the smart card, and transmitting the encrypted VC to the reader;
receiving, by the reader, the first encryption key from an issuing system, which is an issuing entity of the smart card; and
decrypting, by the reader, the encrypted VC based on the first encryption key received from the issuing system.

5. The method of claim 4, further comprising:
encrypting, by the smart card, the generated electronic signature based on the first encryption key stored in the smart card, and transmitting the encrypted electronic signature to the reader.

6. The method of claim 4, further comprising:
generating, by the issuing system, the first encryption key and a second encryption key corresponding to the smart card and transmitting the first encryption key and the second encryption key to the smart card;
storing, by the smart card, the first encryption key and the second encryption key;
generating, by the smart card, the decentralized identifier set including a pair of keys that can be used as an account of a public blockchain network and a decentralized identifier;
transmitting, by the smart card, the decentralized identifier to the smart card; and
updating, by the issuing system, information associated with the decentralized identifier on the public blockchain network.

7. The method of claim 6, further comprising:
issuing, by the issuing system, the VC associated with the smart card;
encrypting, by the issuing system, the VC based on the second encryption key, and transmitting the encrypted VC to the smart card;
decrypting, by the smart card, the encrypted VC based on the second encryption key stored in the smart card; and
storing, by the smart card, the decrypted VC.

8. A smart card comprising:
a communication circuit configured to communicate with a reader associated with an authentication service;
a memory for storing a program associated with the authentication service, a decentralized identifier set, and a VC (Verifiable Credentials) list; and
at least one processor operatively connected to the memory and configured to execute instructions,
wherein the at least one processor is configured to:
transmit a VC included in the VC list and associated with an authentication request to the reader when receiving the authentication request from the reader, and
generate an electronic signature based on a hash value and the decentralized identifier set and transmit the generated electronic signature to the reader, when receiving the hash value generated based on at least a piece of information included in the VC from the reader.

9. The smart card of claim 8, wherein the at least one processor is configured to:
transmit the generated electronic signature to the reader to enable the reader to generate a VP based on the at least a piece of information and the electronic signature.

10. The smart card of claim 9,
wherein the reader operates in conjunction with an issuing system, which is an issuing entity of the smart card, and
wherein the at least one processor is configured to:
receive a first encryption key associated with read permission for the memory and a second encryption key associated with write permission for the memory from the issuing system,
encrypt the VC based on the first encryption key, and transmit the encrypted VC to the reader, and
decrypt a change request for the VC list based on the second encryption key stored in the memory when receiving the change request from the issuing system, and perform a change process based on the decrypted change request.
